(19) United States
(12) Patent Application Publication
(10) Pub. No.: US 2020/0012667 A1
(43) Pub. Date: Jan. 9, 2020

(54) PROPERTY TAX ASSESSMENT

(71) Applicant: U.S. PROPERTY TAX ASSOCIATION, INC., Carbondale, CO (US)

(72) Inventors: Robert A. HILL, Wayzata, MN (US); Stephen D. JAKALA, Maple Grove, MN (US); Andrew R. GEVING, Wyoming, MN (US)

(21) Appl. No.: 16/482,517

(22) PCT Filed: Feb. 6, 2018
(86) PCT No.: PCT/US18/17093

§ 371 Date: Jul. 31, 2019

Related U.S. Application Data
(60) Provisional application No. 62/455,959, filed on Feb. 7, 2017.

(51) Int. Cl. G06F 16/29; G06F 16/9537; G06Q 40/00

(52) U.S. Cl. CPC G06F 16/29; G06Q 40/10; G06F 16/9537

(57) ABSTRACT

Techniques for generating webpages displaying non-physical differences of properties that are physically similar are described. A database may store records, where a record includes geographical information system (GIS) data and financial characteristics of a parcel of real property. A webserver may receive, from a device, a selected record and a request for a set of comparable records that represent parcels of real property that are comparable to the selected parcel. The webserver may query a database, based on the selected record, and receive from the database, the set of comparable records. The webserver may generate a comparables webpage including 1) a graphical map having a graphical depiction for each record in the set, and 2) a table including information for each record in the set. The webserver may transmit the comparables webpage to the device via the network.

### CLAIM OF PRIORITY

This application claims priority to U.S. Provisional Patent Application No. 62/455,959, filed Feb. 7, 2017, the entire contents of which is incorporated herein by reference in its entirety.

### TECHNICAL FIELD

Embodiments described herein generally relate to geographical information systems (GIS).

### BACKGROUND

Physical characteristics of properties are often stored in a GIS, while other property characteristic types (e.g., jurisdictional, financial, temporal, etc.) are often stored in a separate database. Therefore, comparing non-physical differences of properties that are physically similar is a non-trivial task.

### SUMMARY

An embodiment may include a computerized system, which may include a database to store integrated parcel records. Each integrated parcel record may include respective geographical information system (GIS) data of a respective parcel of real property and respective financial characteristics of the parcel of real property. A web server may receive, from a computing device via a network, a selected integrated parcel record. The web server may receive, from the computing device via the network, a request for a set of comparable integrated parcel records, each integrated parcel record in the set being comparable to the selected integrated parcel record. The web server may query the database, based on the selected integrated parcel record, to retrieve the set of comparable integrated parcel records. The web server may receive, from the database, the set of comparable integrated parcel records. The web server may generate a comparables web page. The comparables web page may include a graphical map, which may include a respective graphical depiction for each respective integrated parcel record in the set of comparable integrated parcel records. The comparables web page may also include a table having information for each integrated parcel record in the set of comparable integrated parcel records. The table may comprise rows and columns of data; each column of the table may store data of a particular data field of integrated parcel records, and each row of the table may correspond to a respective integrated parcel record in the set of comparable integrated parcel records. The web server may transmit the comparables web page, via the network, to the computing device.

Another embodiment may include a computerized method, including the steps of: (a) storing integrated parcel records in a database, each integrated parcel record including respective geographical information system (GIS) data of a respective parcel of real property and respective financial characteristics of the parcel of real property; (b) receiving, by a web server from a computing device via a network, a selected integrated parcel record; (c) receiving, by the web server from the computing device via the network, a request for a set of comparable integrated parcel records, each integrated parcel record in the set being comparable to the selected integrated parcel record; (d) querying the database by the web server to retrieve the set of comparable integrated parcel records, the querying based on the selected integrated parcel record; (e) receiving, by the web server from the database, the set of comparable integrated parcel records; (f) generating, by the web server, a comparables web page including: a graphical map including a respective graphical depiction for each respective integrated parcel record in the set of comparable integrated parcel records; and a table including information for each integrated parcel record in the set of comparable integrated parcel records, the table comprising rows and columns of data, each column of the table to store data of a particular integrated parcel record data field, each row corresponding to a respective integrated parcel record in the set of comparable integrated parcel records; and (g) transmitting the comparables web page, by the web server via the network, to the computing device.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments or examples discussed in the present document.

FIG. 1 illustrates a system for integrating GIS records with property tax records, according to an example embodiment.

FIG. 2 is a flow diagram for a process of integrating property records retrieved from a GIS database with property tax information scraped from a property tax database, according to an example embodiment.

FIG. 3 illustrates a system that may be used to search for comparable properties to a subject property, according to an example embodiment.

FIG. 4 is a graphical interface displaying information for a selected subject property, according to an example embodiment.

FIG. 5A is a simple search interface for searching for properties that are comparable to a selected subject property, according to an example embodiment.

FIG. 5B is an advanced search interface for searching for properties that are comparable to a selected subject property, according to an example embodiment.

FIG. 6 illustrates a comparables interface that displays results of a search for properties that are comparable to a selected subject property, according to an example embodiment.

FIGS. 7A and 7B are map displays of two parts of a split parcel, according to an example embodiment.

FIG. 8 is a map display of a combined parcel, according to an example embodiment.

FIG. 9 is a flow diagram of a process performed by an Internet browsing application (e.g., a web browser) for searching for properties that are comparable to a selected subject property, according to an example embodiment.

FIG. 10 illustrates a points of interest (POI) user interface for searching for properties within an area displayed by a map, according to an example embodiment.

FIG. 11 is a block diagram illustrating an example of a machine, upon which any one or more example embodiments may be implemented.

### DETAILED DESCRIPTION

The present disclosure describes methods, systems, and computer program products that individually facilitate finding comparable properties to a subject property. In the following detailed description, for purposes of explanation, numerous specific details are set forth in order to provide a thorough understanding of the various aspects of the presently disclosed subject matter. However, it will be evident to those skilled in the art, after reading and understanding the present subject matter, that the presently disclosed subject matter may be practiced without these specific details. In other instances, well-known methods, procedures, and components have not been described in detail so as not to obscure the presently disclosed subject matter.

Nearly every local government or county of every state in the United States of America imposes real estate taxes (a.k.a., “property taxes”) on real property owned within its jurisdiction; for many counties, real estate taxes are their primary source of revenue. The real estate tax imposed by a county for a property is nearly always calculated as the “fair market value” (FMV) or “estimated market value” (EMV) of the property multiplied by an assessment ratio (which is a stated percentage of the EMV) multiplied by a tax rate: tax=(EMV)×(assessment ratio)×(tax rate). The assessment ratio may vary depending on the type or use of the property. The governing body of the taxing jurisdiction generally sets tax rates. In some jurisdictions, property is taxed based on its “classification,” which is a grouping of properties based on similar use. Examples of classification are residential, commercial, industrial, vacant, and blighted property. Property classification may be used to tax properties at different rates and for different public policy purposes.

Determining the EMV of a property is a critical aspect of real estate taxation, as such value determines the amount of real estate tax due. Various techniques may be used to determine EMV. Except in the case of a recently sold property, EMV has some inherently subjective aspects. Values may change over time, and many states require taxing jurisdictions to re-determine values every three to five years. The EMV of property is often determined based on current use of the property, rather than potential uses. Property values are determined at a particular valuation date for each jurisdiction, which may vary widely.

EMV may be determined based on recent sales of comparable property.

Valuation adjustments may be necessary to achieve comparability. Among the factors considered in determining if a property is comparable to another property may include: the nature of the property (e.g., house, office building, bare land, etc.), property location, property size, property classification (e.g., residential, commercial, farm, etc.), the nature of any improvements to the property, age of improvements to the property, types and uses of buildings on the property, features of the buildings (number of bedrooms, level of amenities, etc.), desirability of the property (e.g., view, proximity to schools, type of access, nearby detracting features, etc.), restrictions on the property (e.g., easements, building code restrictions, physical restrictions, etc.), utility of the property (e.g., fertility of land, drainage or lack thereof, environmental issues, etc.), and general economic conditions.

Property taxes, like all taxes in the United States, are subject to constraints under the United States Constitution and applicable state constitutions. The Equal Protection Clause, which is part of the Fourteenth Amendment to the United States Constitution, has been interpreted by the United States Supreme Court to prohibit state and local governments from assessing property taxes arbitrarily. Nearly all state constitutions impose uniformity and equality rules. Most state constitutions also impose other restrictions, which may vary widely.

Due to some inherently subjective aspects of determining the EMV of a property, assessments of EMV may vary widely. In some cases, an assessed EMV may violate a uniformity and equality rule of a state's constitution and/or the Equal Protection Clause of the Fourteenth Amendment to the United States Constitution. Property owners have a Constitutional right to appeal a property's valuation and taxes, yet most property owners do not have sufficient data to determine if their assessed property taxes abide by the uniformity and equality provision(s) of their state constitution and/or the Equal Protection Clause of the Fourteenth Amendment to the United States Constitution, and to present such data to the relevant appellate body. Thus, what is needed is a way to search for properties within the same taxing jurisdiction that are comparable to a subject property and to compare the attributes (including assessed value) of the comparable properties with those of the subject property.

Finding comparable properties within a jurisdiction is not a trivial task. Many jurisdictions store physical information for properties (or “parcels”) in a GIS and store property tax information for the parcels in a separate database. Thus, some information that may affect the property tax calculation for a property (e.g., square footage) may be stored in the GIS, while the assessed property tax may be stored in a separate database. Therefore, to search for property tax information for comparable properties requires either (1) querying multiple databases and manipulating the query results of the multiple databases or (2) integrating the GIS records with the property tax records and providing a mechanism to query the database(s) housing the integrated records.

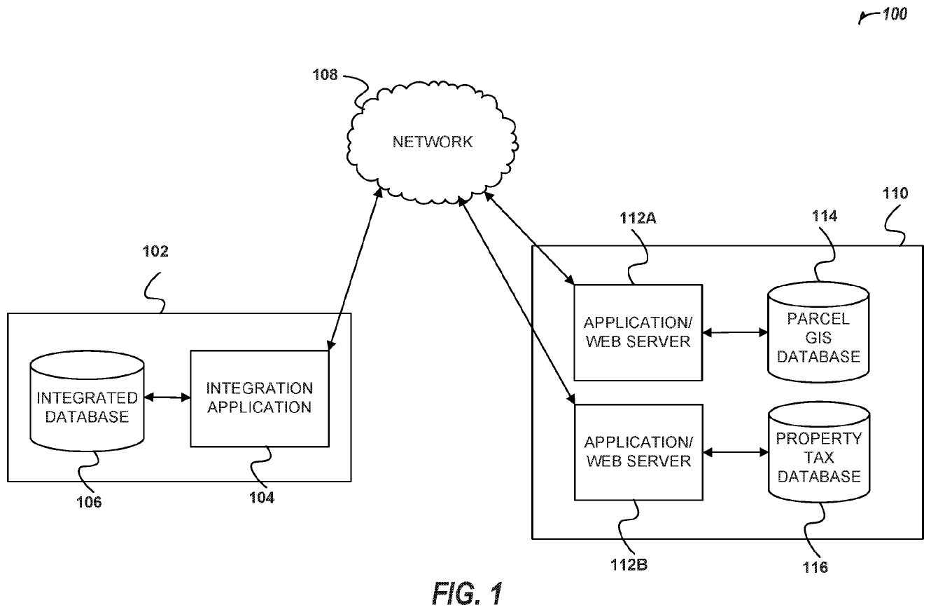

FIG. 1 illustrates a system 100 for integrating GIS records with property tax records, according to an example embodiment. The system 100 may include an integration system 102, a network (e.g., the Internet) 108, and a property tax administration system 110 of a jurisdiction. The integration system 102 may include an integration application 104 and an integrated database 106. The jurisdiction's property tax administration system 110 may include a parcel GIS database 114, which may store GIS information for properties within the jurisdiction. The jurisdiction's property tax administration system 110 may include a property tax database 116, which may store property tax information for properties within the jurisdiction. The jurisdiction's property tax administration system 110 may include an application/web server 112A that communicates, on behalf of the parcel GIS database 114, with computing devices outside of the property tax administration system 110. The jurisdiction's property tax administration system 110 may include an application/web server 112B that communicates, on behalf of the property tax database 116, with computing devices outside of the property tax administration system 110. In an example embodiment, the application/web server 112A is also the application/web server 112B.

The integration process may begin with the integration application 104 generating a GIS query that requests, from the property tax administration system 110, GIS records for properties in the jurisdiction. The GIS query may request a subset of the jurisdiction's properties (e.g., only properties classified as “commercial” properties). The GIS query may differ in form from one jurisdiction to another jurisdiction because database schemas may differ from one jurisdiction to another. The integration application 104 may transmit, via network 108, the GIS query to the application/web server 112A. The application/web server 112A may forward the GIS query to parcel GIS database 114. Parcel GIS database 114 may execute the GIS query, and may return the results of the GIS query to the application/web server 112A. The application/web server 112A may transmit, via network 108, the GIS query results to the integration application 104. In an example embodiment, the integration application 104 may store the GIS query results in the integrated database 106. In another example embodiment, the integration application forwards the GIS query results to the integrated database 106; the integrated database 106 then stores the GIS query results.

The integration application 104 may generate a property tax query that requests, from the property tax administration system 110, property tax information for the properties whose GIS records were included in the GIS query results. The integration application 104 may transmit, via network 108, the property tax query to the application/web server 112B. The application/web server 112B may forward the property tax query to property tax database 116. Property tax database 116 may execute the property tax query, and may return the results of the property tax query to the application/web server 112B.

In an embodiment, the application/web server 112B may transmit to the integration application 104, via network 108, the property tax query results as a database result set. The integration application 104 may forward the database result set to the integrated database 106, which may integrate the GIS records with the database result set containing the property tax information as appropriate.

In another embodiment, the application/web server 112B may transmit to the integration application 104, via network 108, the property tax query results as a web page. The integration application 104 may scrape the web page for the relevant property tax information. The integration application 104 may use one or more of various scraping techniques for each jurisdiction because one jurisdiction may display property tax information differently than another jurisdiction. Scraping techniques may include one or more of submitting a web request to a property tax detail web page to scrape HTML programmatically, programmatically downloading a PDF or other document and extracting text from it, making a web request to a web service endpoint that returns JSON or HTML and parsing it, etc. In an example embodiment, the integration application 104 may forward the scraped property tax information to the integrated database 106; the integrated database 106 then integrates the scraped property tax information with the GIS records as appropriate. In another example embodiment, the integration application 104 may query the integrated database 106 for GIS records to which the scraped property tax information pertains, may integrate the relevant property tax information with the GIS records, and may store the integrated records into the integrated database 106.

In an embodiment, the process(es) of integrating GIS records with property tax records may be performed for multiple jurisdictions and stored in the integrated database 106. In an embodiment, the process(es) of integrating GIS records with property tax records may be performed in “batch” mode. In an embodiment, during execution of the process(es) of integrating GIS records with property tax records, the integrated database 106 and/or an application/web server that handles web communications for the integrated database 106 may refuse to perform user queries against the integrated database 106 until the process(es) of integrating GIS records with property tax records has completed. In an embodiment, the process(es) of integrating GIS records with property tax records into the integrated database 106 may be performed concurrently with executing user queries against the integrated database 106.

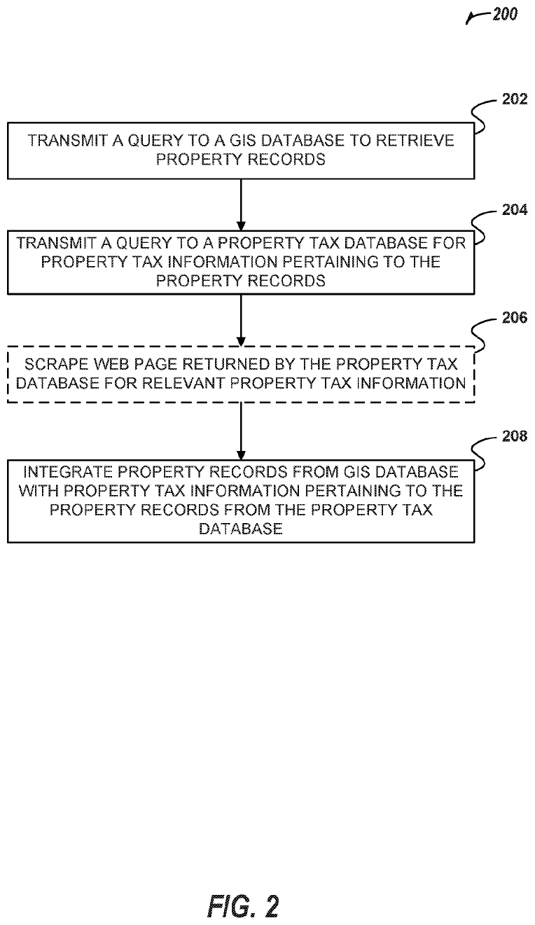

FIG. 2 is a flow diagram for a process 200 of integrating property records retrieved from a GIS database with property tax information scraped from a property tax database, according to an example embodiment. A GIS database of a jurisdiction is queried to retrieve property records (operation 202). A property tax database of the jurisdiction is queried for property tax information pertaining to the retrieved property records (operation 204). Optionally, a web page returned by the property tax information database is scraped for relevant property tax information (operation 206). The property records retrieved from the GIS database are integrated with the property tax information scraped from the property tax database (operation 208). The process 200 may be performed for multiple jurisdictions.

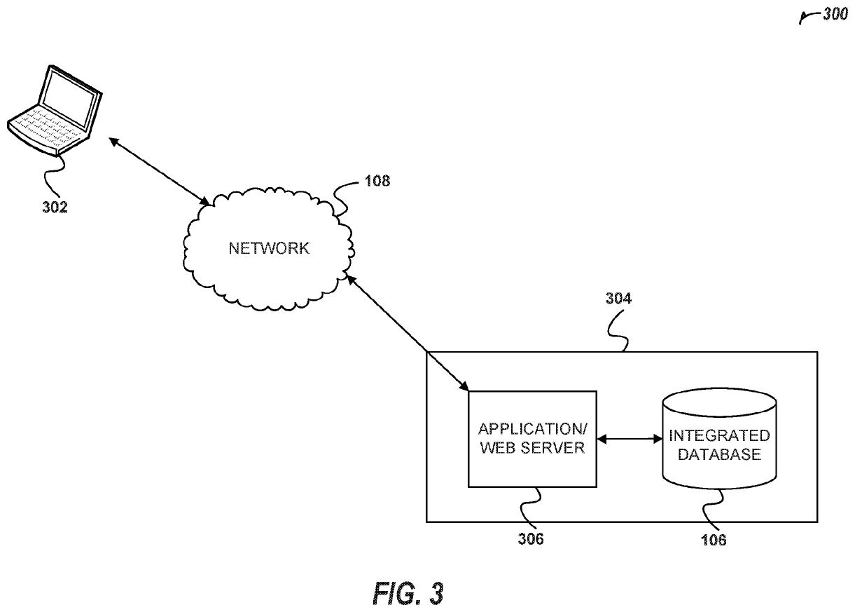

FIG. 3 illustrates a system 300 that may be used to search for comparable properties to a subject property, according to an example embodiment. The system 300 may include a computing device 302, an integrated property information system 304, and a network (e.g., the Internet) 108. The integrated property information system 304 may include an application/web server 306 and the integrated database 106 described above.

The computing device 302 may access a web page, provided by the application/web server 306 via network 108, that allows a user of the computing device 302 to search for properties comparable to a subject property. The user may enter search parameters into one or more input controls, then transmit via network 108 the parameters as a search to the application/web server 306. The application/web server 306 may then generate a query based on the submitted search parameters, and forward the generated query to the integrated database 106. The integrated database 106 may execute the query and return the query results to the application/web server 306. The application/web server 306 may transmit, via network 108, the query results to the computing device 302. Finally, the web browser executing on computing device 302 may present to the user the query results as a web page.

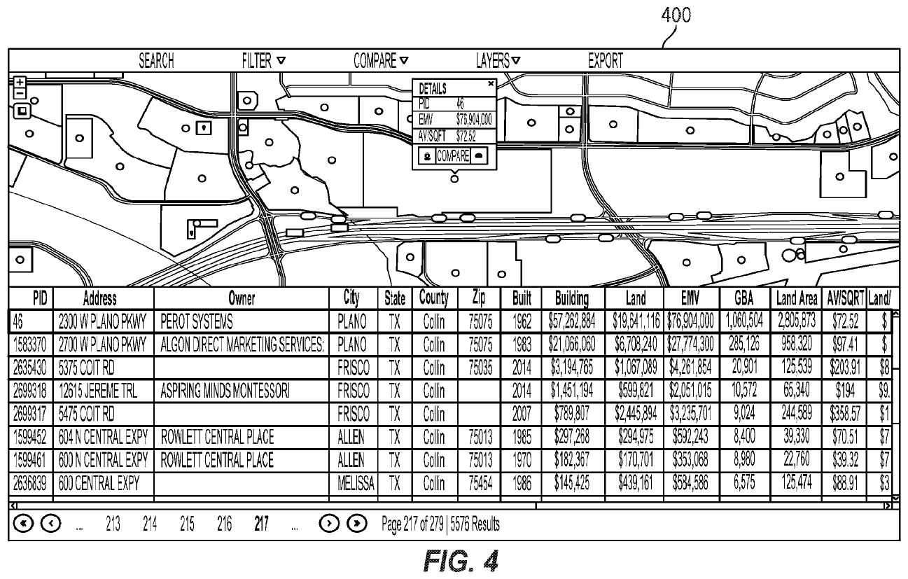

FIG. 4 is a graphical user interface 400 displaying information for a selected subject property, according to an example embodiment. The graphical user interface 400 may include a menu bar, a graphical map, and a table. The graphical map may display a geographical area, and may include zero or more properties. Each property displayed on the graphical map may be displayed with outlined boundaries, and each property may have an icon (e.g., a circle) displayed at or near the center of the property. Each property displayed on the map may have its information displayed in the table. The graphical map may be zoomable. In an embodiment, the properties with information displayed in the table include only those properties that are currently visible on the map; zooming in on the map may cause fewer properties to be listed in the table, whereas zooming out on the map may cause more properties to be listed in the table. Upon a property receiving cursor focus, the map may accentuate the property (e.g., darken the outline of the focused property, fill with a color the area of the focused property, etc.).

The graphical user interface 400 presented by the integrated property tax system may allow a user to select a subject property in a variety of ways. For example, the graphical user interface 400 may allow a user to search for a subject property by entering a property identification number (PID) for the subject property, by entering an address (or part of an address) for the subject property, by selecting an icon that represents the subject property on the map, by selecting a row displaying information for the subject property in the table, etc. As illustrated in FIG. 4, the property with PID of 46 has been selected.

Upon a property being selected (regardless of how the property was selected) the graphical display of the selected subject property may be accentuated and the graphical user interface 400 may display a details tooltip. The details tooltip may list the PID, the estimated market value (EMV), the assessed value per square foot (AV/SQFT), and may include one or more selectable controls. One selectable control, when selected, may cause the web browser to display the property tax information web page for the property (as retrieved from the jurisdiction's property tax database). Another selectable control, when selected, may cause the web browser to display the GIS record for the property (as retrieved from the jurisdiction's GIS system). Another selectable control, when selected, may cause the web browser to display a street view of the property.

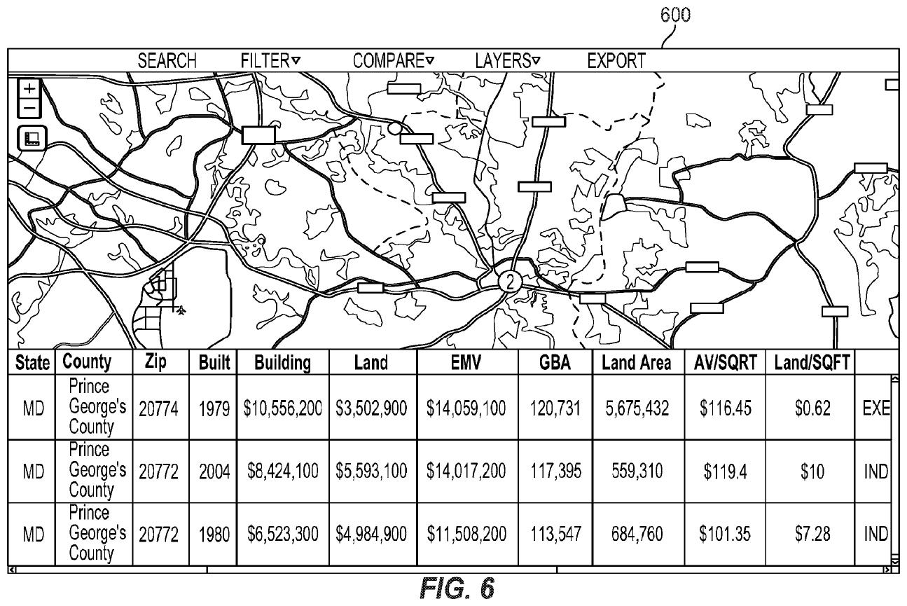

Another selectable control, when selected, may cause the web browser to send a query to the integrated property information system 304, the query requesting that the integrated property information system 304 perform a search for comparable properties using default parameters. In an embodiment, the default parameters may be user-specific (e.g., associated with a particular user account). In an embodiment, the default parameters may include one or more of minimum and/or maximum EMV, minimum and/or maximum gross building area (GBA), and minimum and/or maximum distance from the subject property. In an embodiment, the default parameters may be set to EMV=±20% of the subject property EMV, GBA=±20% of the subject property GBA, and distance=up to 5 miles from the subject property. Upon receiving the results of the query from the integrated property information system 304, the web browser may display the results of the query in a comparables interface (see FIG. 6).

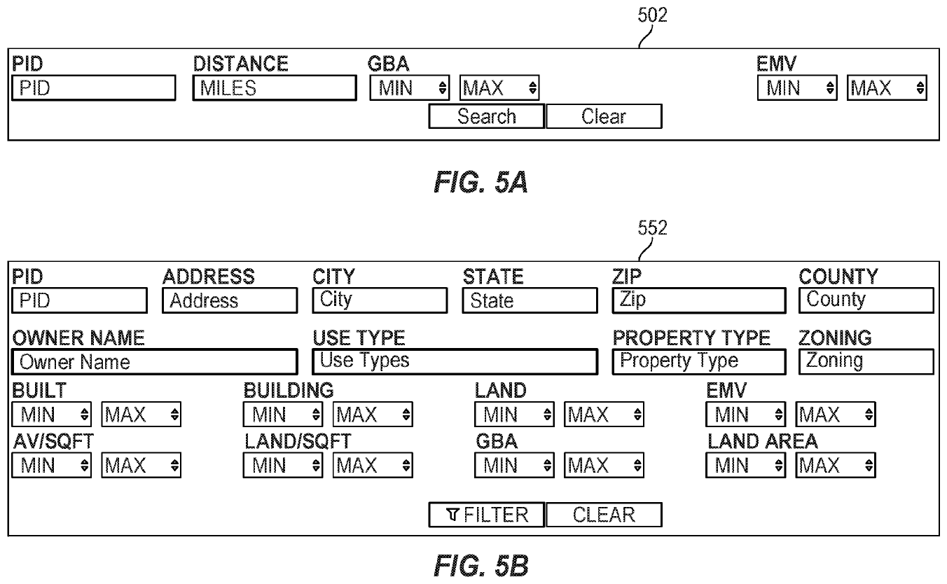

Another selectable control, when selected, may cause the web browser to display a bird's eye view of the property. Another selectable control, when selected, may cause the web browser to display a search interface; the user may use the search interface to enter search facet values for performing the search for properties that are comparable to this selected subject property. FIGS. 5A and 5B illustrate examples of such search interfaces.

FIG. 5A is a simple search interface 502 for searching for properties that are comparable to a selected subject property, according to an example embodiment. The simple search interface 502 may be displayed as part of a web page provided, by an application/web server of the integrated property information system, to a web browser executing on the user's computing device. The simple search interface 502 may include an input control for entering a PID for the subject property. The simple search interface 502 may also include an input control for entering a maximum distance from the subject property to search for comparable properties. The simple search interface 502 may also include an input control for setting the minimum and/or maximum GBA for comparable properties, and another input control for setting the minimum and/or maximum EMV for comparable properties.

Upon selecting the search button, the web browser may transmit, via network 108, the information in the input controls to the application/web server of the integrated property tax system. The application/web server may generate a query that incorporates the information of the input controls, and may submit the generated query to the integrated database. The integrated database may execute the generated query and may forward the results of the query execution to the application/web server. The web server may transmit, via the network 108, the query results to the user's computing device. The web browser of the user's computing device may then display the query results.

FIG. 5B is an advanced search interface 552 for searching for properties that are comparable to a selected subject property, according to an example embodiment. Similar to the simple search interface 502, the advanced search interface 552 may be displayed as part of a web page provided, by an application/web server of the integrated property tax system, to a web browser executing on the user's computing device. The advanced search interface 552 may include an input control for specifying the address of the subject property. In addition to the input controls provided by the simple search interface 502, the advanced search interface 552 may include input controls for specifying search parameters such as city, state, ZIP code, county, owner name, use type, property type, zoning type, minimum and/or maximum year built, minimum and/or maximum building size, minimum and/or maximum AV/SQFT, minimum and/or maximum land/sqft, minimum and/or maximum GBA, and minimum and/or maximum land area.

Upon selecting the search/filter button, the web browser may transmit, via network 108, the information in the input controls of the advanced search interface 552 to the application/web server of the integrated property tax system. The application/web server may generate a query that incorporates the information of the input controls, and may submit the generated query to the integrated database. The integrated database may execute the generated query and may forward the results of the query execution to the application/web server. The web server may transmit, via the network 108, the query results to the user's computing device. The web browser of the user's computing device may then display the query results.

FIG. 6 illustrates a comparables interface 600 that displays results of a search for properties that are comparable to a selected subject property, according to an example embodiment. The comparables interface 600 is a graphical user interface displaying information for properties that are comparable to the subject property. The comparables interface 600 may include a graphical map and a table. The graphical map may display a geographical area corresponding to the geographical area that was searched for comparable properties and the comparable properties identified within the geographical area. In an embodiment, if a maximum distance was specified for the comparable property search, the graphical map may display a circle having the specified maximum distance as its radius and the subject property as its center.

The table of the comparables interface 600 may display information for the comparable properties. The information displayed in the table may include each comparable property's physical and tax information. By analyzing the information listed in the table, the user may determine whether the property tax assessed for the subject property violates the uniformity and equality protections of the respective local, state, and federal governments.

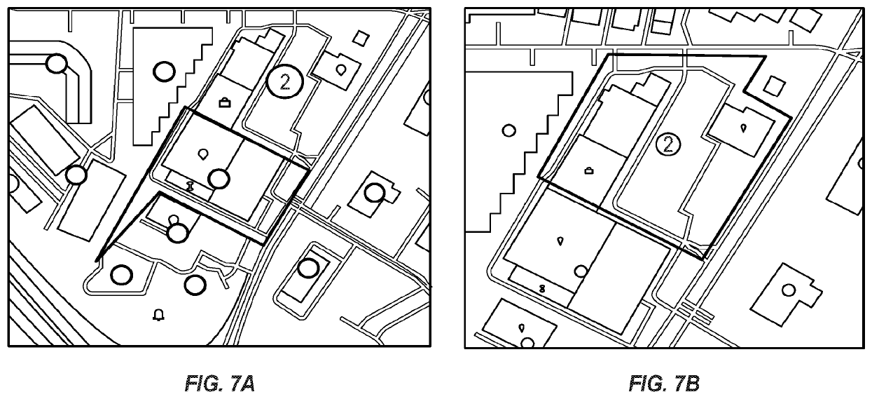

FIGS. 7A and 7B are map displays of two parts of a split parcel, according to an embodiment. In some jurisdictions, a large parcel may be split into multiple smaller parcels. As an example, a large shopping center may be split into multiple parcels, including separate parcels for parking lots or sections of the mall/out lots. The integrated property tax system may allow a user to combine and merge the attributes and geometry data for two or more individual parcels so that the two or more individual parcels may be compared as a single parcel.

In an embodiment, the integrated property tax system may allow a user to manually select the parcels to combine. The integrated property tax system may display the two or more parcels on a map, although the two or more parcels do not have to be displayed at the same time or on the same map. The user may individually select each parcel of the two or more parcels, then select an input control (e.g., a button) to indicate that the selected parcels are to be considered as one parcel for purposes of comparisons with other properties.

In an embodiment, the integrated property tax system may automatically combine some parcels. For example, the integrated property tax system may automatically combine the parcels within a jurisdiction by using the following algorithm. First, the integrated property tax system groups the records within a jurisdiction by owner name, root of address (the address excluding the street number), and city; this grouping identifies parcels that are near each other and that are owned by the same owner. Second, the integrated property tax system determines those records with two or more grouped features and combines the respective records into one respective record. Third, within each respective combined record, the integrated property tax system summarizes the parcel attributes and merges the parcel boundaries into a new feature with combined attributes.

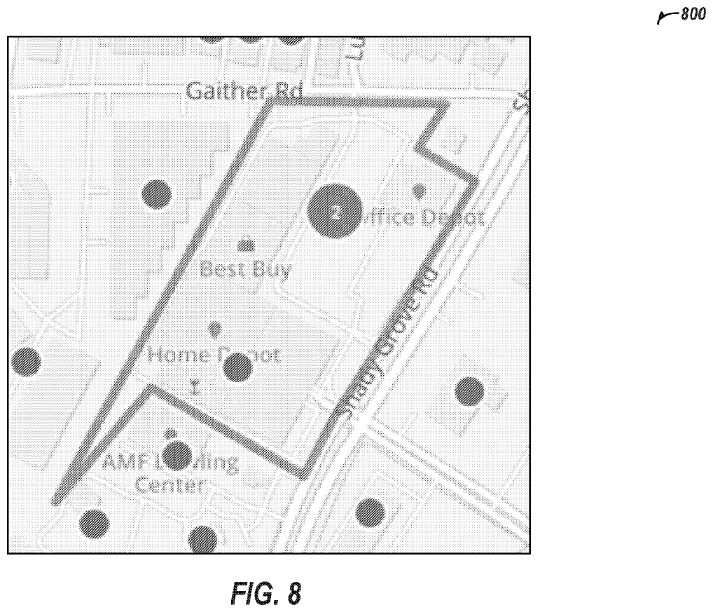

FIG. 8 is a map display of a combined parcel, according to an example embodiment. The combined parcel illustrated in FIG. 8 is the result of combining the individual parcels illustrated in FIGS. 7A and 7B. For future searches of comparable properties during this user's web session, the individual parcels illustrated in FIGS. 7A and 7B will be considered a single parcel (illustrated in FIG. 8). In an embodiment, individual parcels combined into a combined parcel will be considered a single parcel whether the single parcel is the subject property of the comparable property search or whether the single parcel is a possible comparable property for another subject property.

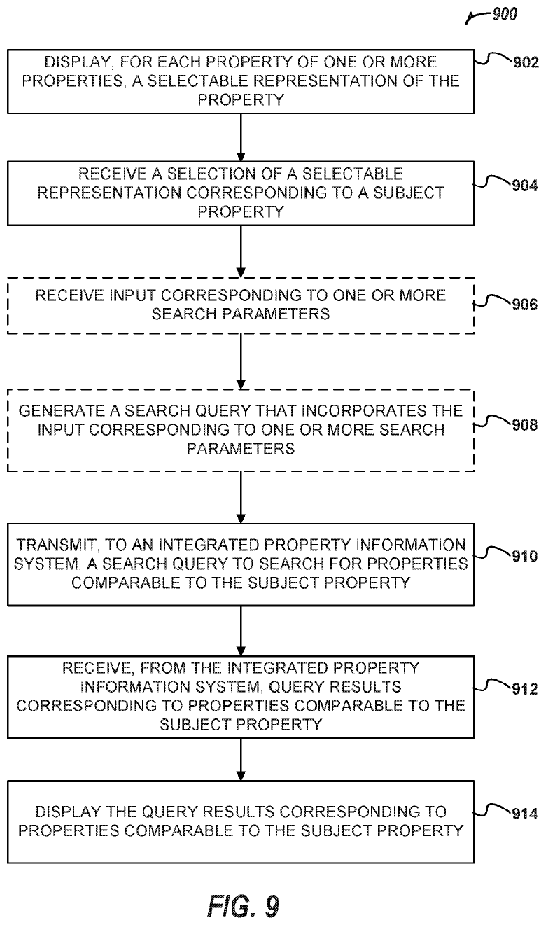

FIG. 9 is a flow diagram of a process 900 performed by an Internet browsing application (e.g., a web browser) for searching for properties that are comparable to a selected subject property, according to an embodiment. For each property of one or more properties, a selectable representation of the property is displayed (operation 902). In an embodiment, a selectable representation of a property may be a standard icon, such as a circle, a star, a triangle, a rectangle, etc. In an embodiment, a selectable representation may be a non-standard icon, such as a polygon corresponding to the borders of the property as seen from an aerial view of the property.

A selection of a selectable representation corresponding to a subject property is received (operation 904). The subject property is one of the one or more properties.

Optionally, input corresponding to one or more search parameters is received (operation 906). The one or more search parameters may correspond to one or more of the input controls of simple search interface 502 and/or advanced search interface 552.

Optionally, a search query is generated that incorporates the input corresponding to the one or more search parameters (operation 908).

A search query is transmitted to an integrated property information system (operation 910). In an embodiment, the search query may be the search query generated in operation 908.

Query results corresponding to properties comparable to the subject property are received from the integrated property information system (operation 912). In an embodiment, the query results may include zero, one, or multiple properties.

The query results corresponding to properties comparable to the subject property are displayed (operation 914). The query results may be displayed similarly to the comparables interface 600.

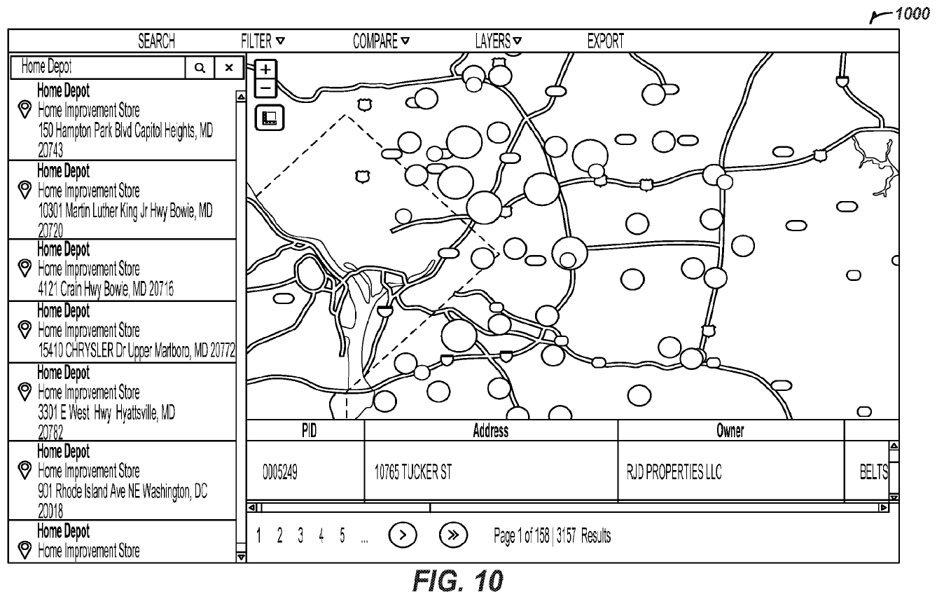

FIG. 10 illustrates a points of interest (POI) user interface 1000 for searching for properties within an area displayed by a map, according to an example embodiment. The POI user interface 1000 may be similar to the comparables interface (as illustrated in FIG. 6) in that the POI user interface 1000 may include a graphical map and a table. However, the POI user interface 1000 also includes a search control that allows a user to enter one or more keywords to search for “points of interest” that are within the area displayed by the map; if one or more points of interest corresponding to the one or more keywords are found, the POI user interface 1000 may then display the one or more points of interest.

For example, the user may enter the name “Home Depot” into the search control and then select a search button. The POI user interface 1000 may then send a query including the string “Home Depot” to the integrated property information system, which may then send a similar query to a search application programming interface (API), such as Google or Bing web services that provide location search APIs that limit search results for a specific search term to a particular geographic region or geographic extent. Upon receiving the search results from the API, the integrated property information system may query the parcel data within the integrated database to match the properties in the search results with the corresponding properties (“points of interest”) that are stored in the integrated database. For example, the integrated database may store parcel polygon data as geometric features, thus enabling spatial intersection queries (e.g., STIntersects) such as determining if a particular geographic point (e.g., latitude and longitude) is within a parcel polygon.

The integrated property information system may then transmit information of the corresponding properties that match the properties in the search results to the POI user interface 1000 executing on the user's device. Finally, the POI user interface 1000 may display the matched properties on one or more of the map, the table, and the search control.

The integrated property information system may provide customized alerting services to its users. For example, a user may register with the integrated property information system and associate a property to the user's account. The user may indicate that the user wishes to be notified if a specified condition evaluates to true. For example, the user may wish to be notified if the percentage increase in the property's AV/SQFT is disproportionately larger than the percentage increase of the average AV/SQFT for comparable properties within a specified area (e.g., if the property's percentage increase is more than 5% higher than the percentage increase of the average AV/SQFT for comparable properties within the property's county.) This type of notification may alert a user that the property taxes assessed for the property might have increased beyond what may be considered “uniform and equal.” Upon receiving such a notification, the user may take corrective action (e.g., contesting the assessed value for the property). To implement such functionality, the system may first calculate for each property the annual percentage change in the property's EMV using the formula (C L)/C, where C is the EMV for the current year and L is the EMV for the previous year. Then, for a subject property, the system may perform a search for comparable properties and compare the percentage change in the EMVs for the comparable properties to the percentage change in EMV for the subject property. This alerting process may be performed on an as-needed basis, yearly, or on a period that is programmatically set. Furthermore, for a given property, the comparables search that is performed to determine percentage change in EMV may use default parameters, user-specific parameters, or a combination thereof.

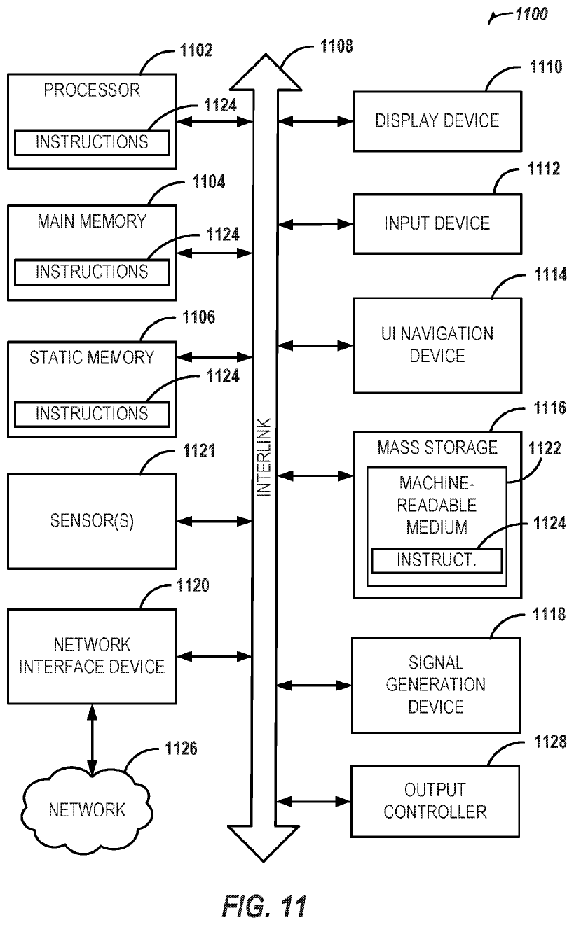

FIG. 11 is a block diagram illustrating an example of a machine 1100, upon which any one or more example embodiments may be implemented. In alternative embodiments, the machine 1100 may operate as a standalone device or may be connected (e.g., networked) to other machines. In a networked deployment, the machine 1100 may operate in the capacity of a server machine, a client machine, or both in a client-server network environment. In an example, the machine 1100 may act as a peer machine in a peer-to-peer (P2P) (or other distributed) network environment. The machine 1100 may implement or include any portion of the systems, devices, or methods illustrated in FIGS. 1-10, and may be a computer, a server, or any machine capable of executing instructions (sequential or otherwise) that specify actions to be taken by that machine. Further, although only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations, etc.

Examples, as described herein, may include, or may operate by, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 1100 may include a hardware processor 1102 (e.g., a central processing unit (CPU), a graphics processing unit (GPU), a hardware processor core, or any combination thereof), a main memory 1104 and a static memory 1106, some or all of which may communicate with each other via an interlink (e.g., bus) 1108. The machine 1100 may further include a display unit 1110, an alphanumeric input device 1112 (e.g., a keyboard), and a user interface (UI) navigation device 1114 (e.g., a mouse). In an example, the display unit 1110, input device 1112 and UI navigation device 1114 may be a touch screen display. The machine 1100 may additionally include a storage device (e.g., drive unit) 1116, a signal generation device 1118 (e.g., a speaker), a network interface device 1120, and one or more sensors 1121, such as a global positioning system (GPS) sensor, compass, accelerometer, or other sensor. The machine 1100 may include an output controller 1128, such as a serial (e.g., USB, parallel, or other wired or wireless (e.g., infrared (IR), near field communication (NFC), etc.) connection to communicate or control one or more peripheral devices (e.g., a printer, card reader, etc.)

The storage device 1116 may include a machine-readable medium 1122 on which is stored one or more sets of data structures or instructions 1124 (e.g., software) embodying or utilized by any one or more of the techniques or functions described herein. The instructions 1124 may also reside, completely or at least partially, within the main memory 1104, within static memory 1106, or within the hardware processor 1102 during execution thereof by the machine 1100. In an example, one or any combination of the hardware processor 1102, the main memory 1104, the static memory 1106, or the storage device 1116 may constitute machine-readable media.

Although the machine-readable medium 1122 is illustrated as a single medium, the term “machine-readable medium” may include a single medium or multiple media (e.g., a centralized or distributed database, and/or associated caches and servers) configured to store the one or more instructions 1124.

The term “machine-readable medium” may include any medium that is capable of storing, encoding, or carrying instructions for execution by the machine 1100 and that cause the machine 1100 to perform any one or more of the techniques of the present disclosure, or that is capable of storing, encoding or carrying data structures used by or associated with such instructions. Non-limiting machine-readable medium examples may include solid-state memories, and optical and magnetic media. Accordingly, machine-readable media are not transitory propagating signals. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks.

The instructions 1124 may further be transmitted or received over a communications network 1126 using a transmission medium via the network interface device 1120 utilizing any one of a number of transfer protocols (e.g., frame relay, Internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMAX®), IEEE 802.15.4 family of standards, Bluetooth®, Bluetooth® low energy technology, ZigBee®, peer-to-peer (P2P) networks, among others. In an example, the network interface device 1120 may include one or more physical jacks (e.g., Ethernet, coaxial, or phone jacks) or one or more antennas to connect to the communications network 1126. In an example, the network interface device 1120 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1100, and includes digital or analog communications signals or other intangible medium to facilitate communication of such software.

Conventional terms in the fields of computer systems and computer networking have been used herein. The terms are known in the art and are provided only as a non-limiting example for convenience purposes. Accordingly, the interpretation of the corresponding terms in the claims, unless stated otherwise, is not limited to any particular definition.

Although specific embodiments have been illustrated and described herein, it will be appreciated by those of ordinary skill in the art that any arrangement that is calculated to achieve the same purpose may be substituted for the specific embodiments shown. Many adaptations will be apparent to those of ordinary skill in the art. Accordingly, this application is intended to cover any adaptations or variations.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. Moreover, in the following claims, the terms “first,” “second,” and “third,” etc. are used merely as labels, and are not intended to impose numerical requirements on their objects. In this document, a sensor set may include one or more sensors, which may be of different types. Furthermore, two different sensor sets may include one or more sensors that belong to both sensor sets.

In this Detailed Description, various features may have been grouped together to streamline the disclosure. This should not be interpreted as intending that an unclaimed disclosed feature is essential to any claim. Rather, inventive subject matter may lie in less than all features of a particular disclosed embodiment.

The above description is intended to be illustrative, and not restrictive. For example, the above-described examples (or one or more aspects thereof) may be used in combination with each other. Other embodiments may be used, such as by one of ordinary skill in the art upon reviewing the above description.

1. A computerized system, comprising:
a database to store integrated parcel records, each integrated parcel record including respective geographical information system (GIS) data of a respective parcel of real property and respective financial characteristics of the parcel of real property; and
a web server to:
receive, from a computing device via a network, a selected integrated parcel record;
receive, from the computing device via the network, a request for a set of comparable integrated parcel records, each integrated parcel record in the set being comparable to the selected integrated parcel record;
query the database, based on the selected integrated parcel record, to retrieve the set of comparable integrated parcel records;
receive, from the database, the set of comparable integrated parcel records;
generate a comparables web page including:
a graphical map including a respective graphical depiction for each respective integrated parcel record in the set of comparable integrated parcel records; and
a table including information for each integrated parcel record in the set of comparable integrated parcel records, the table comprising rows and columns of data, each column of the table to store data of a particular data field of integrated parcel records, each row corresponding to a respective integrated parcel record in the set of comparable integrated parcel records; and
transmit the comparables web page, via the network, to the computing device.

2. The computerized system of claim 1, wherein the table comprises rows and columns of data;
wherein one of the rows and columns includes a particular integrated parcel record data field listing at least one parameter that caused the integrated parcel record to be included in the set of comparable integrated parcel records; and
wherein a second of the rows and columns includes a particular integrated parcel record data field listing indicating the values for each integrated parcel record in the set of comparable integrated parcel records, whereby the second one of the rows and columns permits a side-by-side comparison of the values of each integrated parcel record in the set of comparable integrated parcel records.

3. The computerized system of claim 1, wherein a respective integrated parcel record is comparable to the selected integrated parcel record upon the respective parcel of real property represented by the respective integrated parcel record being within at least one of:
a selected distance from the parcel of property represented by the selected integrated parcel record;
a selected range of gross building area (GBA); and
a selected range of estimated market value (EMV).

4. The computerized system of claim 3, wherein the selected distance from the parcel of property represented by the selected integrated parcel record is a default distance of 5 miles.

5. The computerized system of claim 3, wherein the selected range of GBA is a default range of 80% to 120% of the GBA of the parcel of real property represented by the respective integrated parcel record.

6. The computerized system of claim 3, wherein the selected range of EMV is a default range of 80% to 120% of the EMV of the parcel of real property represented by the respective integrated parcel record.

7. The computerized system of claim 1, wherein a respective integrated parcel record is comparable to the selected integrated parcel record upon the respective parcel of real property represented by the respective integrated parcel record being at least one of:
located within a selected city;
located within a selected county;
located within a selected ZIP code;
located within a selected state;
having a selected use type;
having a selected property type;
having a selected zoning type;
built within a selected date range;
having a building square footage within a selected square footage range;
having a land area within a selected area range; and
having an assessed value per square foot (AV/SQFT) within a selected range of AV/SQFT.

8. The computerized system of claim 1, wherein to receive a selection for the selected integrated parcel record, the web server is to:
generate a web page including:
a geographical map of a geographical area, the geographical map including selectable graphical representations of a plurality of parcels of real property within the geographical area; and
a selectable table including selectable information for each parcel of real property within the plurality of parcels of real property represented in the geographical map;
transmit, via the network, the generated web page to the computing device; and
receive, from the computing device via the network, a selection of a second plurality of parcels of real property, the selection input received by at least one of: the geographical map and the selectable table;
wherein the web server is to treat the set of integrated parcel records for the second plurality of parcels of real property as the selected integrated parcel record.

9. The computerized system of claim 8, wherein each graphical depiction of each parcel of real property within the second plurality of parcels of real property includes a respective outermost boundary; and
wherein the graphical depiction for the selected integrated parcel record within the graphical map of the comparables web page is a union of the outermost boundaries of the graphical depictions of each of the parcels of real property within the second plurality of parcels of real property.

10. The computerized system of claim 8, wherein the information for the selected integrated parcel record within the table of the comparables web page is a combination of the information of each of the parcels of real property within the second plurality of parcels of real property.

11. A computerized method, comprising:
storing integrated parcel records in a database, each integrated parcel record including respective geographical information system (GIS) data of a respective parcel of real property and respective financial characteristics of the parcel of real property;
receiving, by a web server from a computing device via a network, a selected integrated parcel record;
receiving, by the web server from the computing device via the network, a request for a set of comparable integrated parcel records, each integrated parcel record in the set being comparable to the selected integrated parcel record;
querying the database by the web server to retrieve the set of comparable integrated parcel records, the querying based on the selected integrated parcel record;
receiving, by the web server from the database, the set of comparable integrated parcel records;
generating, by the web server, a comparables web page including:
a graphical map including a respective graphical depiction for each respective integrated parcel record in the set of comparable integrated parcel records; and
a table including information for each integrated parcel record in the set of comparable integrated parcel records, the table comprising rows and columns of data, each column of the table to store data of a particular integrated parcel record data field, each row corresponding to a respective integrated parcel record in the set of comparable integrated parcel records; and
transmitting the comparables web page, by the web server via the network, to the computing device.

12. The computerized method of claim 11, wherein the table comprises rows and columns of data;
wherein one of the rows and columns includes a particular integrated parcel record data field listing at least one parameter that caused the integrated parcel record to be included in the set of comparable integrated parcel records; and
wherein a second of the rows and columns includes a particular integrated parcel record data field listing indicating the values for each integrated parcel record in the set of comparable integrated parcel records, whereby the second one of the rows and columns permits a side-by-side comparison of the values of each integrated parcel record in the set of comparable integrated parcel records.

13. The computerized method of claim 11, wherein a respective integrated parcel record is comparable to the selected integrated parcel record upon the respective parcel of real property represented by the respective integrated parcel record being within at least one of:
a selected distance from the parcel of property represented by the selected integrated parcel record;
a selected range of gross building area (GBA); and
a selected range of estimated market value (EMV).

14. The computerized method of claim 13, wherein the selected distance from the parcel of property represented by the selected integrated parcel record is a default distance of 5 miles.

15. The computerized method of claim 13, wherein the selected range of GBA is a default range of 80% to 120% of the GBA of the parcel of real property represented by the respective integrated parcel record.

16. The computerized method of claim 13, wherein the selected range of EMV is a default range of 80% to 120% of the EMV of the parcel of real property represented by the respective integrated parcel record.

17. The computerized method of claim 11, wherein a respective integrated parcel record is comparable to the selected integrated parcel record upon the respective parcel of real property represented by the respective integrated parcel record being at least one of:
located within a selected city;
located within a selected county;
located within a selected ZIP code;
located within a selected state;
having a selected use type;
having a selected property type;
having a selected zoning type;
built within a selected date range;
having a building square footage within a selected square footage range;
having a land area within a selected area range; and
having an assessed value per square foot (AV/SQFT) within a selected range of AV/SQFT.

18. The computerized method of claim 11, wherein to receive a selection for the selected integrated parcel record includes:
generating, by the web server, a web page including:
a geographical map of a geographical area, the geographical map including selectable graphical representations of a plurality of parcels of real property within the geographical area; and
a selectable table including selectable information for each parcel of real property within the plurality of parcels of real property represented in the geographical map;
transmitting, by the web server via the network, the generated web page to the computing device; and
receiving, by the web server from the computing device via the network, a selection of a second plurality of parcels of real property, the selection input received by at least one of: the geographical map and the selectable table;
wherein the web server treats the set of integrated parcel records for the second plurality of parcels of real property as the selected integrated parcel record.

19. The computerized method of claim 18, wherein each graphical depiction of each parcel of real property within the second plurality of parcels of real property includes a respective outermost boundary; and
wherein the graphical depiction for the selected integrated parcel record within the graphical map of the comparables web page is a union of the outermost boundaries of the graphical depictions of each of the parcels of real property within the second plurality of parcels of real property.

20. The computerized method of claim 18, wherein the information for the selected integrated parcel record within the table of the comparables web page is a combination of the information of each of the parcels of real property within the second plurality of parcels of real property.

21. (canceled)

22. (canceled)
